(19) United States
(12) Patent Application Publication
(10) Pub. No.: US 2026/0200486 A1
(43) Pub. Date: Jul. 16, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takuya Niioka, Tokyo (JP); Ryo Mukainakano, Tokyo (JP)

(21) Appl. No.: 19/443,066

(22) Filed: Jan. 8, 2026

(30) Foreign Application Priority Data
Jan. 16, 2025 (JP) 2025-006030

(51) Int. Cl. B60W 50/08; B60W 50/14; G07C 5/02

(52) U.S. Cl. CPC B60W 50/087; B60W 50/14; G07C 5/02; B60W 2050/146; B60W 2420/403; B60W 2540/215; B60W 2540/30; B60W 2720/106

(57) ABSTRACT

A vehicle control device includes a determiner configured to determine an abnormality of a driver based on a state of the driver of a vehicle, a behavior of the vehicle, or a vehicle state that is an output state of an abnormality signal indicating that an abnormality button indicating occurrence of the abnormality of the driver has been operated and a controller configured to execute deceleration control for decelerating the vehicle based on the vehicle state determined by the determiner. The controller makes a cancellation condition for the deceleration control stricter when an abnormality level is higher than when the abnormality level is lower.

### CROSS-REFERENCE TO RELATED APPLICATION

Priority is claimed on Japanese Patent Application No. 2025-006030, filed January 16, 2025, the content of which is incorporated herein by reference.

### BACKGROUND OF THE INVENTION

### Field of the Invention

The present invention relates to a vehicle control device, a vehicle control method, and a storage medium.

### Description of Related Art

In recent years, efforts to provide sustainable transportation systems that consider various situations have become more active. For this realization, research and development (R&D) related to driving assistance technologies has focused on further improving traffic safety and convenience. For example, when it is detected that a steering amount correlation value (such as steering torque and steering angle), which changes when a vehicle’s steering wheel (SW) is operated, remains unchanged for an abnormality determination threshold time or more, a driving assistance electronic control unit (ECU) determines that the driver is in an abnormal state, decelerates the vehicle, makes a hazard lamp blink, and invalidates an acceleration request based on a change in an accelerator pedal operation (i.e., prohibits accelerator override). Technology in which the deceleration of the vehicle is stopped and the accelerator override is permitted when the driving assistance ECU determines that there is a specific driving operation (an operation in which an accelerator pedal changes from an operating state to a non-operating state and then again changes to the operating state within a predetermined threshold time) after the driver is determined to be in the abnormal state is disclosed (see, for example, Japanese Unexamined Patent Application, First Publication No. 2017-144808).

### SUMMARY OF THE INVENTION

In conventional technology, the cancellation of deceleration is not performed according to a state of a driver.

An objective of an aspect of the present invention is to provide a vehicle control device, a vehicle control method, and a storage medium that can enable deceleration control to be appropriately cancelled in accordance with a state of a driver. This aspect of the present invention contributes to the development of sustainable transportation systems.

A control device, a control method, and a storage medium according to the present invention adopt the following configurations.

According to an aspect of the present invention, there is provided a vehicle control device including: a determiner configured to determine an abnormality of a driver based on a state of the driver of a vehicle, a behavior of the vehicle, or a vehicle state that is an output state of an abnormality signal indicating that an abnormality button indicating occurrence of the abnormality of the driver has been operated; and a controller configured to execute deceleration control for decelerating the vehicle based on the vehicle state determined by the determiner, wherein the controller makes a cancellation condition for the deceleration control stricter when an abnormality level is higher than when the abnormality level is lower.

In the above-described aspect (1), when the abnormality level is higher, the abnormality level of the state of the driver is higher or the abnormality of the state of the driver continues for a longer period of time than when the abnormality level is lower.

In the above-described aspect (1), the controller determines the abnormality of the driver based on states of two or three combinations among the state of the driver determined by analyzing an image obtained by imaging the driver, a state in which the vehicle is controlled by the driver, and a dynamic state of the vehicle.

In the above-described aspect (1), the controller cancels the deceleration control when a first task is completed if the abnormality level is a first predetermined level, and the controller cancels the deceleration control when a second task, which is easier to accomplish than the first task, is completed if the abnormality level is a second predetermined level lower than the first predetermined level.

In the above-described aspect (1), the controller cancels the deceleration control based on one or more states of a state of control of the vehicle of the driver, a state of an operation on the vehicle other than a driving operation of the driver, and a state of an operation on an operation element inside a display device for providing information provided in the vehicle of the driver or an operation element provided near the display device, in addition to the state of the driver determined by analyzing an image obtained by imaging the driver.

In the above-described aspect (5), the controller determines the state of the control of the vehicle based on one or both of an operation amount and an operation time of a driving operation element of the driver.

In the above-described aspect (5), the controller determines a state of an operation on the vehicle other than the driving operation based on a state of an operation with respect to a switch provided on a steering wheel or near the steering wheel.

In the above-described aspect (5), the display device is a display device arranged between a driver seat and a passenger seat of the vehicle in relation to a width direction of the vehicle.

In the above-described aspect (1), when the deceleration control is started, the controller controls steering of the vehicle so that the vehicle travels within a travel lane in which the vehicle is traveling.

In the above-described aspect (1), the controller determines whether the driver is in a state of any one of first, second, and third abnormality levels, the first abnormality level is determined based on (a) an image obtained by imaging the driver, the second abnormality level is determined based on (a) the image obtained by imaging the driver, (b) an operation of the driver for an operation element, or (c) the behavior of the vehicle, and the third abnormality level is determined based on (a) the image obtained by imaging the driver, (b) the operation of the driver for the operation element, (c) the behavior of the vehicle, or (d) the output state of the abnormality signal indicating that the abnormality button indicating the occurrence of the abnormality of the driver has been operated.

In the above-described aspect (10), a cancellation condition for the deceleration control at the first abnormality level is determined based on (e) an operation of the driver for an operation element, a cancellation condition for the deceleration control at the second abnormality level is determined based on (f) an image obtained by imaging the driver in addition to (e) the operation of the driver for the operation element, and a cancellation condition for the deceleration control at the third abnormality level is determined based on (g) an operation task that becomes more difficult to accomplish than an operation task of (e) the operation of the driver for the operation element, or (h) an operation for operating a predetermined button provided in the vehicle.

According to another aspect of the present invention, there is provided a vehicle control method including: determining, by a computer, an abnormality of a driver based on a state of the driver of a vehicle, a behavior of the vehicle, or a vehicle state that is an output state of an abnormality signal indicating that an abnormality button indicating occurrence of the abnormality of the driver has been operated; executing, by the computer, deceleration control for decelerating the vehicle based on the determined vehicle state; and making, by the computer, a cancellation condition for the deceleration control stricter when an abnormality level is higher than when the abnormality level is lower.

According to yet another aspect of the present invention, there is provided a computer-readable non-transitory storage medium storing a program for causing a computer to execute: a process for determining an abnormality of a driver based on a state of the driver of a vehicle, a behavior of the vehicle, or a vehicle state that is an output state of an abnormality signal indicating that an abnormality button indicating occurrence of the abnormality of the driver has been operated; and a process for executing deceleration control for decelerating the vehicle based on the determined vehicle state, wherein a cancellation condition for the deceleration control is made stricter when an abnormality level is higher than when the abnormality level is lower.

According to the aspects (1) to (13), a vehicle control device can appropriately cancel deceleration control in accordance with a state of a driver by making a cancellation condition for the deceleration control stricter when an abnormality level is higher than when the abnormality level is lower.

### BRIEF DESCRIPTION OF THE DRAWINGS

FIG. 1 is a configuration diagram of a vehicle system using a vehicle control system according to an embodiment.

FIG. 2 is a diagram showing an example of content of reference information.

FIG. 3 is a flowchart showing an example of a process executed by a driving assistance device.

FIG. 4 is a flowchart showing another example of the process executed by the driving assistance device.

### DETAILED DESCRIPTION OF THE INVENTION

### Overall configuration

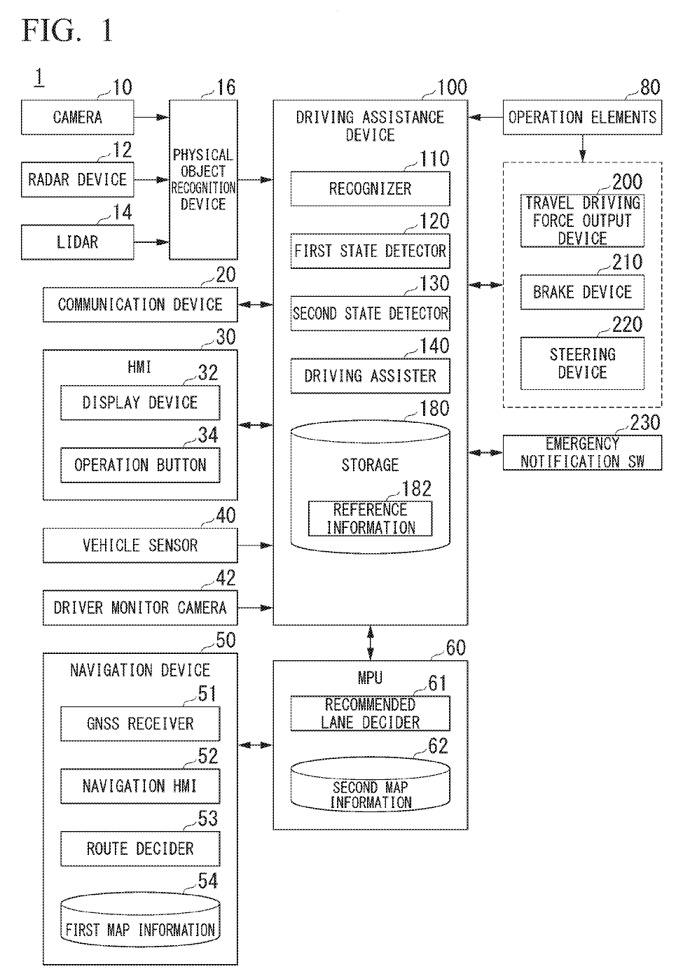

FIG. 1 is a configuration diagram of a vehicle system 1 using a vehicle control system according to an embodiment. A vehicle on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Although the case where the present embodiment is applied to a vehicle will be described, the present invention may be applied to other mobile objects instead of a vehicle.

For example, the vehicle system 1 includes a camera 10, a radar device 12, a light detection and ranging (LIDAR) 14, a physical object recognition device 16, a communication device 20, a human machine interface (HMI) 30, a vehicle sensor 40, a driver monitor camera 42, a navigation device 50, a map positioning unit (MPU) 60, operation elements 80, a driving assistance device (vehicle control device) 100, a travel driving force output device 200, a brake device 210, a steering device 220, and an emergency notification switch (SW). Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “control device.”

For example, the camera 10 is a digital camera using a solid-state imaging element such as a charge-coupled device (CCD) or a complementary metal oxide semiconductor (CMOS). The camera 10 is attached to any location on a vehicle (hereinafter, a vehicle M) where the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme.

The LIDAR 14 radiates light (or electromagnetic waves having a wavelength close to that of light) around the vehicle M and measures scattered light. The LIDAR 14 detects a distance from a target based on a period of time from light emission to light reception. The radiated light is, for example, pulsed laser light. The LIDAR 14 is attached to any location of the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the driving assistance device 100. The physical object recognition device 16 may output detection results of the camera 10, the radar device 12, and the LIDAR 14 to the driving assistance device 100 as they are. The physical object recognition device 16 may be omitted from the vehicle system 1.

The communication device 20, for example, communicates with another vehicle located in the vicinity of the vehicle M using a cellular network, a Wi-Fi network, Bluetooth (registered trademark), dedicated short-range communication (DSRC), or the like or communicates with various types of server devices via a radio base station.

The HMI 30 presents various types of information to an occupant of the vehicle M and receives an input operation from the occupant. The HMI 30 includes various types of display devices, a speaker, a buzzer, a touch panel, a switch, keys, and the like. The HMI 30 includes a display device. The display device is, for example, a display device, i.e., a multi-information display, configured to display various information in the vehicle M such as a speedometer indicating a traveling speed of the vehicle M or a tachometer indicating the number of rotations (a rotational speed) of the internal combustion engine provided in the vehicle M.

The HMI 30 includes, for example, a display device 32 and an operation button 34. The display device 32 is a display device that shows maps or vehicle information, installed on or near a center console between the driver and passenger seats.

The operation button 34 is, for example, a selector switch provided on a spoke of the steering wheel. Operating the selector switch switches the display content of the multi-information display provided in front of the driver seat.

The vehicle sensor 40 includes a vehicle speed sensor configured to detect the speed of the vehicle M, an acceleration sensor configured to detect acceleration, a yaw rate sensor configured to detect angular velocity around a vertical axis, a direction sensor configured to detect an orientation of the vehicle M, and the like.

The driver monitor camera 42 is a camera that captures an image of the driver of the vehicle M. The driver monitor camera 42 is mounted at a position where the driver is captured from the front inside the vehicle M.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle M can travel along a reasonable route for traveling to a branching destination when there is a branch point on the route on the map. For example, when the vehicle M reaches a position that is a predetermined distance before a branch path that the vehicle M is scheduled to enter, the recommended lane decider 61 decides a lane connecting to the branch path as the recommended lane. The recommended lane decider 61 and the second map information 62 may be a functional unit or information included in another device such as the driving assistance device 100. The driving assistance device 100 recommends the driver to move the vehicle M to the recommended lane or automatically moves the vehicle M.

The second map information 62 is map information with higher accuracy than the first map information 54. The second map information 62 includes, for example, information about a center of a lane, information about a boundary of the lane, or the like. The second map information 62 may include road information, traffic regulation

information, address information (address/postal code), facility information, telephone number information, and the like. The second map information 62 may be updated at any time by the communication device 20 communicating with other devices.

The operation elements 80 include, for example, a steering wheel, an accelerator pedal, a brake pedal, a shift lever, and other operation elements. A sensor for detecting an amount of operation or the presence or absence of an operation is attached to the operation element 80 and a detection result thereof is output to the driving assistance device 100 or some or all of the travel driving force output device 200, the brake device 210, and the steering device 220. The steering wheel does not necessarily have to be annular and may be in the form of a variant steering wheel, a joystick, a button, or the like.

The driving assistance device 100 includes, for example, a recognizer 110, a first state detector 120, a second state detector 130, a driving assister 140, and a storage 180. The recognizer 110, the first state detector 120, the second state detector 130, and the driving assister 140 are implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The program may be pre-stored in the storage 180 (a storage device including a non-transitory storage medium) such as an HDD or a flash memory in the driving assistance device 100 or may be stored in a removable storage medium such as a DVD or a CD-ROM and installed in an HDD or a flash memory of the driving assistance device 100 when the storage medium (the non-transitory storage medium) is mounted in a drive device. For example, reference information 182 to be described below is stored in the storage 180. One or both of the first state detector 120 and the second state detector 130 are examples of a “determiner.” The driving assister 140 is an example of a “controller.”

On the basis of information input from the camera 10, the radar device 12, and the LIDAR 14 via the physical object recognition device 16, the recognizer 110 recognizes a state of a position, velocity, acceleration, or the like of a physical object in the vicinity of the vehicle M. The position of the physical object, for example, is recognized as a position of an absolute coordinate system having a representative point of the vehicle M (a center of gravity, a drive shaft center, or the like) as the origin, and is used for control. The position of the physical object may be represented by a representative point such as the center of gravity or a corner of the physical object or may be represented by an area. The “state” of the physical object may include the acceleration or jerk of the physical object, or the “action state” (e.g., whether or not the vehicle is changing lanes or is about to change lanes).

The recognizer 110 recognizes a lane in which the vehicle M is traveling (a travel lane). For example, the recognizer 110 recognizes the travel lane by comparing a pattern of road markings (e.g., an arrangement of solid lines and broken lines) obtained from the second map information 62 with a pattern of road markings in the vicinity of the vehicle M recognized from an image captured by the camera 10. The recognizer 110 may recognize the travel lane by recognizing a travel path boundary (a road boundary) including a road marking, a road shoulder, a curb, a median strip, a guardrail, and the like as well as a road marking. In this recognition, a position of the vehicle M acquired from the navigation device 50 or a processing result of the INS may be taken into account. The recognizer 110 recognizes a temporary stop line, an obstacle, a red traffic light, and a toll gate, and other road events.

When the travel lane is recognized, the recognizer 110 recognizes a position or an orientation of the vehicle M with respect to the travel lane. For example, the recognizer 110 may recognize a deviation of a reference point of the vehicle M from the center of the lane and an angle formed between the travel direction of the vehicle M and a line connected to the center of the lane as a relative position and orientation of the vehicle M related to the travel lane. Alternatively, the recognizer 110 may recognize the position of the reference point of the vehicle M for any side end of the travel lane (the road marking or the road boundary) or the like as a position of the vehicle M relative to the travel lane.

The first state detector 120 determines whether or not the driver is in an abnormal state by analyzing an image captured by the driver monitor camera 42. For example, the first state detector 120 recognizes the driver’s head, eyes, and eyelids from the image and determines an abnormality of the driver based on states thereof. For example, when the head is not facing forward but tilted in a direction such as an upward direction or a downward direction different from the forward direction that is the reference direction, when a gaze direction is facing in a direction different from the reference direction, when the eyelids are closed, or the like, the first state detector 120 determines that the driver is in the abnormal state.

The first state detector 120 also determines whether or not the driver is in a normal state. The first state detector 120, for example, analyzes the image as described above and determines whether or not the states of the driver's head, eyes, and eyelids is preset normal states.

The second state detector 130 detects the state of the vehicle M, operations on the driver’s operation elements 80, and the like. For example, the second state detector

130 detects the state of the vehicle M based on information acquired from the vehicle sensor 40. The states of the vehicle M are acceleration/deceleration, swaying, and the like. Operations of the driver for the operation elements are an operation on the accelerator pedal, an operation on the brake pedal, and an operation on the steering wheel, and operation levels and operation times thereof and the like are given.

The driving assister 140 executes driving assistance control. For example, the driving assister 140 automatically controls the travel driving force output device 200 and the brake device 210 without relying on the driver’s operation, thereby automatically controlling the speed of the vehicle M. The driving assister 140 executes so-called adaptive cruise control (ACC). The driving assister 140 controls the vehicle M so that the vehicle M travels at a set speed, or causes the vehicle M to travel while tracking a preceding vehicle at a predetermined distance from the preceding vehicle.

The driving assister 140 controls the steering device 220 so that the vehicle M does not deviate from the travel lane. For example, the driving assister 140 controls the steering device 220 so that the vehicle M travels near or along the center of the travel lane recognized by the recognizer 110. This control may hereinafter be referred to as “lane keeping control.” The controller 150 executes hands-on lane keeping control and hands-off lane keeping control.

The hands-on lane keeping control is control that is executed in a state in which the driver is grasping the steering wheel (i.e., a steering grasp sensor (not shown) detects that the steering wheel is being grasped). A condition under which the hands-on lane keeping control can be executed is less strict than a condition under which the hands-off lane keeping control can be executed.

The hands-off lane keeping control is control that is executed in a state in which the driver is not grasping the steering wheel (i.e., the steering grasp sensor (not shown) does not detect that the steering wheel is being grasped). The hands-off lane keeping control can be executed, for example, when the following conditions are satisfied. The conditions are that the vehicle M is traveling at a predetermined speed or more, that the vehicle M is traveling on a predetermined road (e.g., a road or type of road on which the hands-off lane keeping control is set as executable), and that the driver is performing forward monitoring. The hands-off lane keeping control is executed when the driver is performing forward monitoring and the hands-off lane keeping control is not executed, or is stopped, when the driver is not performing forward monitoring.

A condition under which the above-described hands-on lane keeping control and hands-off lane keeping control can be executed is only an example; other conditions (e.g., the vehicle M is tracking a preceding vehicle) may be included, or some conditions may be omitted. It is only necessary for the conditions under which the hands-on lane keeping control can be executed to be less strict than the conditions under which the hands-off lane keeping control can be executed (i.e., it is only necessary for the condition under which the hands-off lane keeping control can be executed to be stricter than the condition under which the hands-on lane keeping control can be executed). The driving assistance device 100 recognizes whether the driver is performing forward monitoring based on images captured by a camera (not shown) that images the driver.

The travel driving force output device 200 outputs a travel driving force (torque) for enabling the traveling of the vehicle to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving assistance device 100 or the information input from the operation element 80 so that brake torque according to a braking operation is output to each wheel.

For example, the steering device 220 includes a steering ECU and an electric motor. For example, the electric motor changes directions of steerable wheels by applying a force to a rack and pinion mechanism. The steering ECU drives the electric motor in accordance with the information input from the driving assistance device 100 or the information input from the operation element 80 to change the directions of the steerable wheels.

The emergency notification SW 230, for example, is attached to a position where the emergency notification SW 230 can be operated by the driver or the occupant in the vehicle cabin of the vehicle M. The emergency notification SW, for example, may be attached to the ceiling between the driver seat and the passenger seat. The driver or occupant operates the emergency notification SW when an abnormality occurs in the driver, the vehicle M, or the like. The driving assistance device 100 controls the vehicle M so that the vehicle M can safely stop based on a signal according to the operation.

### Overview

The driving assistance device 100 controls the vehicle M so that the vehicle M safely travels or stops when it is estimated that an abnormality has occurred in the driver or that an abnormality is occurring. For example, the driving assistance device 100 determines an abnormality of the driver based on a state of the driver of the vehicle M, a behavior of the vehicle M, or a vehicle state that is an output state of an abnormality signal indicating that an abnormality button (e.g., the emergency notification SW 230) indicating the occurrence of the abnormality of the driver has been operated. The driving assistance device 100 executes deceleration control for decelerating the vehicle M based on the determined vehicle state. The driving assistance device 100 makes a cancellation condition for the deceleration control stricter when the abnormality level is higher than when the abnormality level is lower. Hereinafter, this control will be described.

When the abnormality level is higher, the abnormality level of the state of the driver is higher, or the abnormality of the state of the driver continues for a longer period of time than when the abnormality level is lower.

The driving assistance device 100 determines the abnormality of the driver based on states of any one, two or three combinations among the state of the driver determined by analyzing an image obtained by imaging the driver, a state in which the vehicle M is controlled by the driver, and a dynamic state of the vehicle M. The state in which the vehicle M is controlled is, for example, a state of the operation of the driver for the operation element (the accelerator pedal, the brake pedal, the steering wheel, or the like). The dynamic state of the vehicle M refers to a change in the behavior of the vehicle M, such as swaying of the vehicle M or a sudden change in acceleration or deceleration of the vehicle M.

### Reference information

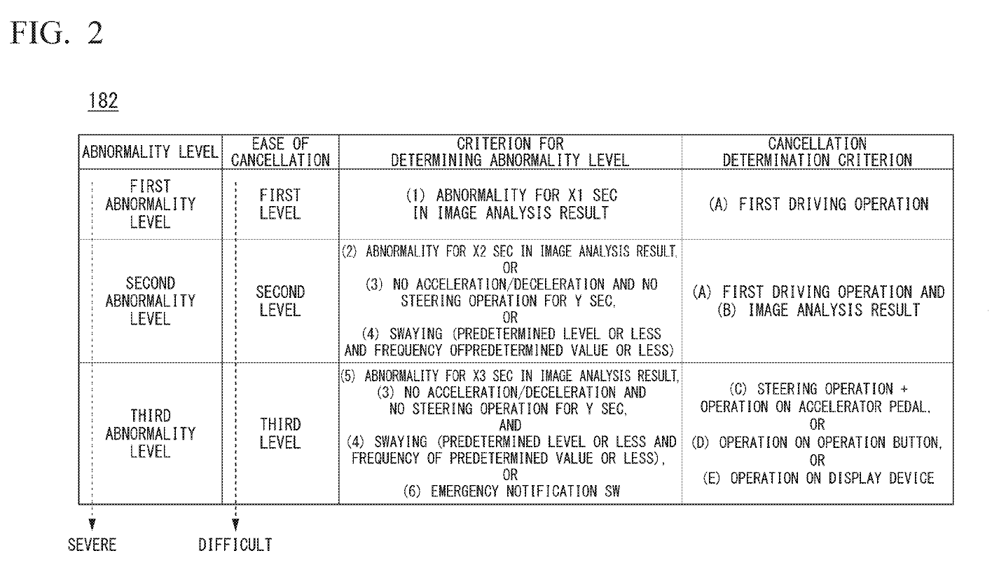

The driving assistance device 100 determines the abnormality of the driver and the cancellation of deceleration control with reference to the reference information 182 shown in FIG. 2. FIG. 2 is a diagram showing an example of the content of the reference information 182. The reference information 182 includes, for example, the abnormality level, the ease of cancellation of deceleration control executed when an abnormality has occurred, a criterion for determining the abnormality, and a criterion for determining the cancellation of the deceleration control.

The abnormality levels include, for example, a first abnormality level, a second abnormality level, and a third abnormality level. The abnormality levels become more severe in the order of the first, second, and third abnormality levels. The first abnormality level is, for example, a state in which the driver is slightly drowsy or has a reduced response. The second abnormality level is, for example, a state of moderate drowsiness or absent-mindedness or the like. The third abnormality level is, for example, a state in which the driver needs to be rescued or is asleep or the like.

The ease of the cancellation includes a first level, a second level, and a third level. The cancellation becomes more difficult in the order of the first level, the second level, and the third level.

### Criterion for determining first abnormality level

A criterion for determining the first abnormality level is that condition (1) is satisfied.

(1) In a result of analyzing an image captured by the driver monitor camera 42, a state estimated as abnormal for the driver continues for X1 sec.

### Criterion for determining second abnormality level

The criterion for determining the second abnormality level is that condition (2), (3), or (4) is satisfied.

(2) In a result of analyzing an image captured by the driver monitor camera 42, a state estimated as abnormal for the driver continues for X2 sec, where X2 sec is a period of time longer than X1 sec.

(3) A state in which there are no acceleration/deceleration operations or steering operations by the driver continues for Y sec.

(4) A state in which the vehicle M is swaying satisfies a set standard. The swaying state is, for example, a state in which the vehicle M is moving while continuously changing a position in a width direction such as a state in which the vehicle M is traveling at a first position that is a predetermined distance or more in the above-described width direction from a predetermined position such as the center of the road or lane as a reference position of the vehicle M or a state in which the vehicle M is traveling between different positions on the road or lane in the width direction while moving within a predetermined period of time. The fact that the set standard is satisfied means that the swaying state continues for a predetermined period of time or that an operation in which the vehicle M moves to a right position in relation to the width direction and moves to a left position is iterated a predetermined number of times (e.g., three or four times).

### Criterion for determining third abnormality level

A criterion for determining the third abnormality level is that conditions (5), (3), and (4) are all satisfied, or condition (6) is satisfied.

(5) In a result of analyzing an image captured by the driver monitor camera 42, a state estimated as abnormal for the driver continues for X3 sec, where X3 sec is a period of time longer than X2 sec.

(6) The emergency notification SW has been operated.

In the above-described determination, an abnormality score may be used. For example, the driving assistance device 100 may derive a score corresponding to the content of the above-described conditions (1) to (4) and determine whether or not the score falls within a score range set for each abnormality level. The driving assistance device 100 may determine a type of abnormality level in accordance with the corresponding range. For example, scores may be derived from information such as the durations in the conditions (1) to (3) (the driver’s consciousness, operation aspect, and swaying level), and these scores may be combined to determine the abnormality level.

### Criterion for determining cancellation of first abnormality level

A criterion for determining cancellation of the first abnormality level is that a condition (A) is satisfied.

(A) A first driving operation has been performed. The first driving operation is a light driving operation, and is, for example, a steering wheel grasping operation, an operation on the accelerator pedal at the first level or more, an operation on the brake pedal at the second level or more, or the like.

### Criteria for determining cancellation of second abnormality level

A criterion for cancelling the second abnormality level is that both conditions (A) and (B) are satisfied.

(B) In a result of analyzing an image captured by the driver monitor camera 42, it is estimated that the driver is not in an abnormal state, or that a state estimated as non-abnormal has continued for a predetermined number of seconds.

### Criterion for determining cancellation of third abnormality level

A criterion for releasing the third abnormality level is that a condition (C), (D), or (E) is satisfied. (C) An operation on the steering wheel and an operation on the accelerator pedal have been performed. The operation on the steering wheel is an operation for grasping the steering wheel or applying a steering torque of a predetermined level or more to the steering wheel. The operation on the accelerator pedal is, for example, depressing the accelerator pedal by a predetermined level a predetermined number of times (e.g., twice). In the above-described condition (C), the control state of the vehicle M is determined based on one or both of the operation amount and operation time of the driving operation element operated by the driver. For example, it is only necessary to perform the determination based on one or more information items among the steering wheel operation, the operation time of the steering wheel operation, the accelerator pedal operation, and the operation time of the accelerator pedal operation.

(D) A predetermined operation has been performed on the operation button 34. The predetermined operation may be a pre-defined operation or an operation designated in the display of the multi-information display. In other words, the driving assistance device 100 “determines the state of the operation of the vehicle other than the driving operation based on the state of the operation on the switch provided on or near the steering wheel.”

(E) A predetermined operation has been performed on the display device 32. The predetermined operation may be a pre-defined operation or an operation designated in the display of the display device 32. The display device 32 is an example of a “display device arranged between the driver seat and the passenger seat of the vehicle in the vehicle width direction.”

The third abnormality level is an example of a “first predetermined level,” and the second abnormality level is an example of a “second predetermined level.” A task for a cancellation condition of the third abnormality level is an example of a “first task” of the “criterion for determining the cancellation of the first predetermined level.” A task for a cancellation condition of the second abnormality level is an example of a “second task” of the “criteria for determining the cancellation of the second predetermined level.”

In the above-described example, to cancel an abnormal state, the driving assistance device 100 may cancel the deceleration control based on one or more states of (C) a state of control of the vehicle of the driver, (D) a state of an operation on the vehicle other than a driving operation of the driver, and (E) a state of an operation on an operation element inside the display device 32 for providing information provided in the vehicle M of the driver or an operation element provided near the display device 32 in addition to the state of the driver determined by analyzing an image obtained by imaging the driver. The driving assistance device 100 may perform cancellation based on one or more of the conditions (C), (D), and (E) in addition to the state of the driver determined by analyzing the image so that the state of the first or second abnormality level is cancelled, or (B) a result of analyzing the image obtained by imaging the driver may be used to cancel the state of the third abnormality level.

For example, it is only necessary to make the conditions stricter in the order of a condition of cancellation of the deceleration control at the time of the first abnormality level, a condition of cancellation of the deceleration control at the time of the second abnormality level, and a condition of cancellation of the deceleration control at the time of the third abnormality level.

In the above-described determination, a cancellation score may also be used. For example, the driving assistance device 100 derives scores according to the content of the above-described conditions (A) to (E) and determines whether or not the score falls within the score range in which the score is set for each cancellation condition of the abnormality level. The driving assistance device 100 determines whether or not the cancellation condition for the target abnormality level is satisfied. For example, scores may be derived from the operation patterns of the condition (A), the driver’s state obtained from the condition (B), and the operation pattern of the condition (C), the operation patterns of the conditions (D) and (E), and the like, and these scores may be combined and determined.

Although three abnormality levels have been described in the above-described example, the number of levels is not limited to three and may be two or four. Likewise, in this case, it is only necessary for the cancellation condition for deceleration control to be stricter when the abnormality level becomes more severe.

### Flowchart (1)

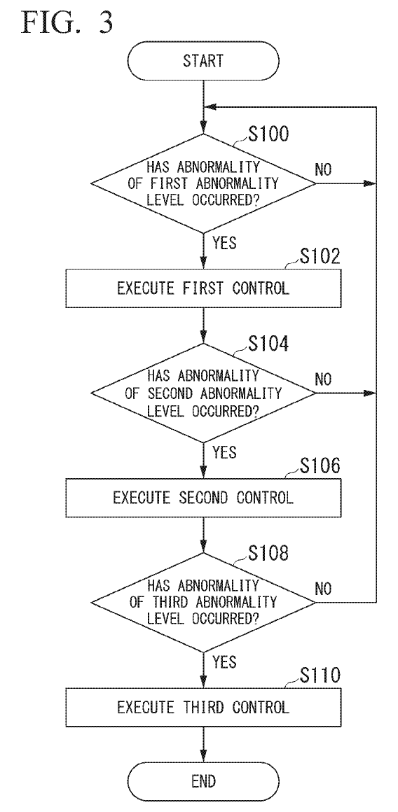

FIG. 3 is a flowchart showing an example of a flow of a process executed by the driving assistance device 100. This process is a process for determining the abnormality level of the driver. In the present flowchart, it is assumed that ACC and lane keeping control are being executed.

First, the driving assistance device 100 determines whether or not an abnormality of the first abnormality level has occurred in the driver (step S100). When the abnormality of the first abnormality level has occurred, the driving assistance device 100 executes first control (step S102). The first control is control for stopping the execution of ACC and executing lane keeping control. According to the first control, the vehicle M decelerates.

Subsequently, the driving assistance device 100 determines whether or not an abnormality of the driver at the second abnormality level has occurred (step S104). When an abnormality of the second abnormality level has occurred, the driving assistance device 100 executes second control (step S106). The second control is control for executing lane keeping control and disabling the operation when the accelerator pedal is being operated. By the second control, the vehicle M is further decelerated.

Subsequently, the driving assistance device 100 determines whether or not an abnormality of the driver at the third abnormality level has occurred (step S108). When the abnormality of the third abnormality level has occurred, the driving assistance device 100 executes third control (step S110). The third control is control for stopping the vehicle M, or control for safely stopping the vehicle M on the road shoulder. By the third control, the vehicle M is further decelerated. Thereby, the process of one routine of the present flowchart ends.

As described above, the driving assistance device 100 can appropriately control the vehicle M in accordance with the abnormality level of the driver.

### Flowchart (2)

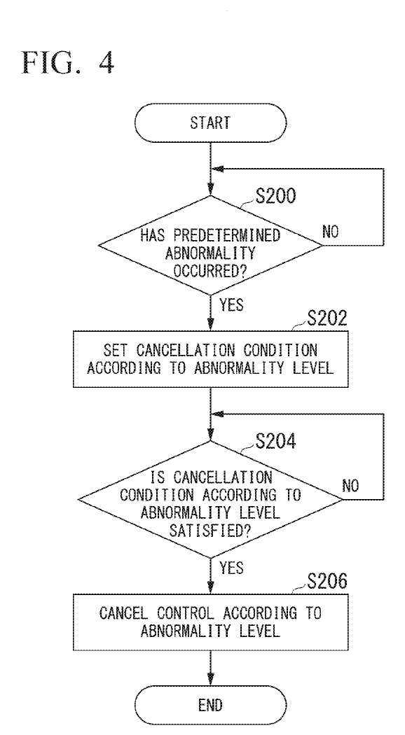

FIG. 4 is a flowchart showing another example of a flow of a process executed by the driving assistance device 100. This process is a process for cancelling the control being executed due to the driver’s abnormality.

First, the driving assistance device 100 determines whether or not an abnormality has occurred in the driver (step S200). When an abnormality has occurred, the driving assistance device 100 sets a cancellation condition according to the abnormality level (step S202). Subsequently, the driving assistance device 100 determines whether or not the cancellation condition according to the abnormality level is satisfied (step S204). In relation to the cancellation condition according to the abnormality level, for example, when the abnormality level is the first abnormality level, the cancellation condition for the first abnormality level is set, and it is determined whether or not this cancellation condition is satisfied.

When the cancellation condition is satisfied, the driving assistance device 100 cancels the control according to the abnormality level that is being executed (step S206). For example, when the first control is being executed and the cancellation condition for the first abnormality level is satisfied, the driving assistance device 100 cancels the first control. Thereby, the process of one routine of the present flowchart ends.

As described above, the driving assistance device 100 can appropriately control the vehicle M by appropriately cancelling the control according to the abnormality level when it is estimated that the control according to the abnormality level of the driver can be cancelled. For example, by changing the cancellation condition according to the abnormality level, when the driver’s state is normal, the deceleration control can be easily cancelled. Moreover, because the more severe the abnormality level is, the stricter the cancellation condition is, in a state in which an abnormality has occurred in the driver and deceleration control should be executed, the deceleration control is reliably continued so that the vehicle M is safely controlled. In this way, the driving assistance device 100 can appropriately cancel the deceleration control in accordance with the driver’s state.

Although the description has been given on the assumption that driving assistance of the vehicle M is being executed in the above-described embodiment, the above-described process may be executed when the vehicle M is performing automated driving in place thereof (or in addition thereto).

According to the embodiment described above, the driving assistance device 100 determines an abnormality of the driver based on a state of the driver of the vehicle M, a behavior of the vehicle M, or a vehicle state that is an output state of an abnormality signal indicating that an abnormality button indicating occurrence of the abnormality of the driver has been operated, executes deceleration control for decelerating the vehicle M based on the determined vehicle state; and makes a cancellation condition for the deceleration control stricter when an abnormality level is higher than when the abnormality level is lower, such that the deceleration control can be appropriately cancelled according to the driver’s state.

### The embodiment described above can be represented as follows.

A control device including:

a storage device storing a program; and

a hardware processor, the hardware processor executing the program stored in the storage device to:

determine an abnormality of a driver based on a state of the driver of a vehicle, a behavior of the vehicle, or a vehicle state that is an output state of an abnormality signal indicating that an abnormality button indicating occurrence of the abnormality of the driver has been operated;

execute deceleration control for decelerating the vehicle based on the determined vehicle state; and

make a cancellation condition for the deceleration control stricter when an abnormality level is higher than when the abnormality level is lower.

Although modes for carrying out the present invention have been described using embodiments, the present invention is not limited to the embodiments and various modifications and substitutions can also be made without departing from the scope of the present invention.

What is claimed is:

1. A vehicle control device comprising:
a determiner configured to determine an abnormality of a driver based on a state of the driver of a vehicle, a behavior of the vehicle, or a vehicle state that is an output state of an abnormality signal indicating that an abnormality button indicating occurrence of the abnormality of the driver has been operated; and
a controller configured to execute deceleration control for decelerating the vehicle based on the vehicle state determined by the determiner,
wherein the controller makes a cancellation condition for the deceleration control stricter when an abnormality level is higher than when the abnormality level is lower.

2. The vehicle control device according to claim 1, wherein, when the abnormality level is higher, the abnormality level of the state of the driver is higher, or the abnormality of the state of the driver continues for a longer period of time than when the abnormality level is lower.

3. The vehicle control device according to claim 1, wherein the controller determines the abnormality of the driver based on states of two or three combinations among the state of the driver determined by analyzing an image obtained by imaging the driver, a state in which the vehicle is controlled by the driver, and a dynamic state of the vehicle.

4. The vehicle control device according to claim 1,
wherein the controller cancels the deceleration control when a first task is completed if the abnormality level is a first predetermined level, and
wherein the controller cancels the deceleration control when a second task, which is easier to accomplish than the first task, is completed if the abnormality level is a second predetermined level lower than the first predetermined level.

5. The vehicle control device according to claim 1, wherein the controller cancels the deceleration control based on one or more states of a state of control of the vehicle of the driver, a state of an operation on the vehicle other than a driving operation of the driver, and a state of an operation on an operation element inside a display device for providing information provided in the vehicle of the driver or an operation element provided near the display device, in addition to the state of the driver determined by analyzing an image obtained by imaging the driver.

6. The vehicle control device according to claim 5, wherein the controller determines the state of the control of the vehicle based on one or both of an operation amount and an operation time of a driving operation element of the driver.

7. The vehicle control device according to claim 5, wherein the controller determines a state of an operation on the vehicle other than the driving operation based on a state of an operation with respect to a switch provided on a steering wheel or near the steering wheel.

8. The vehicle control device according to claim 5, wherein the display device is a display device arranged between a driver seat and a passenger seat of the vehicle in relation to a width direction of the vehicle.

9. The vehicle control device according to claim 1, wherein, when the deceleration control is started, the controller controls steering of the vehicle so that the vehicle travels within a travel lane in which the vehicle is traveling.

10. The vehicle control device according to claim 1,
wherein the controller determines whether the driver is in a state of any one of first, second, and third abnormality levels,
wherein the first abnormality level is determined based on (a) an image obtained by imaging the driver,
wherein the second abnormality level is determined based on (a) the image obtained by imaging the driver, (b) an operation of the driver for an operation element, or (c) the behavior of the vehicle, and
wherein the third abnormality level is determined based on (a) the image obtained by imaging the driver, (b) the operation of the driver for the operation element, (c) the behavior of the vehicle, or (d) the output state of the abnormality signal indicating that the abnormality button indicating the occurrence of the abnormality of the driver has been operated.

11. The vehicle control device according to claim 10,
wherein a cancellation condition for the deceleration control at the first abnormality level is determined based on (e) an operation of the driver for an operation element,
wherein a cancellation condition for the deceleration control at the second abnormality level is determined based on (f) an image obtained by imaging the driver in addition to (e) the operation of the driver for the operation element, and
wherein a cancellation condition for the deceleration control at the third abnormality level is determined based on (g) an operation task that becomes more difficult to accomplish than an operation task of (e) the operation of the driver for the operation element, or (h) an operation for operating a predetermined button provided in the vehicle.

12. A vehicle control method comprising:
determining, by a computer, an abnormality of a driver based on a state of the driver of a vehicle, a behavior of the vehicle, or a vehicle state that is an output state of an abnormality signal indicating that an abnormality button indicating occurrence of the abnormality of the driver has been operated;
executing, by the computer, deceleration control for decelerating the vehicle based on the determined vehicle state; and
making, by the computer, a cancellation condition for the deceleration control stricter when an abnormality level is higher than when the abnormality level is lower.

13. A computer-readable non-transitory storage medium storing a program for causing a computer to execute:
a process for determining an abnormality of a driver based on a state of the driver of a vehicle, a behavior of the vehicle, or a vehicle state that is an output state of an abnormality signal indicating that an abnormality button indicating occurrence of the abnormality of the driver has been operated; and
a process for executing deceleration control for decelerating the vehicle based on the determined vehicle state,
wherein a cancellation condition for the deceleration control is made stricter when an abnormality level is higher than when the abnormality level is lower.
